(19) United States
(12) Patent Application Publication
(10) Pub. No.: US 2014/0324624 A1
(43) Pub. Date: Oct. 30, 2014

(54) WINE RECOMMENDATION SYSTEM AND METHOD

(71) Applicants: Richard Ward, Winchester, MA (US); Dave Towne, San Carlos, CA (US); David H. Stannard, Newberg, OR (US); Peter Lachapelle, Toronto (CA)

(72) Inventors: Richard Ward, Winchester, MA (US); Dave Towne, San Carlos, CA (US); David H. Stannard, Newberg, OR (US); Peter Lachapelle, Toronto (CA)

(21) Appl. No.: 14/232,383

(22) PCT Filed: Jul. 12, 2012
(86) PCT No.: PCT/US2012/046480

§ 371 Date: Jul. 11, 2014

Related U.S. Application Data
(60) Provisional application No. 61/506,797, filed on Jul. 12, 2011.

(51) Int. Cl. G06Q 30/06

(52) U.S. Cl. CPC G06Q 30/0631
USPC 705/26.7

(57) ABSTRACT

A computer readable medium comprises instructions, which when executed by a data processor of a portable electronic device, cause the data processor to obtain a list of wines available at a commercial establishment; and identify at least one attribute associated with each wine included on the list of wines. The instructions further cause the data processor to, for each wine included on the list of wines, determine a score indicative of a likelihood that the user will purchase the wine on the basis of the at least one attribute and at least one of a characteristic associated with the user and a preference input by the user. Based on the score, the instructions further cause the data processor to identify at least one recommended wine for recommendation to the user; and present the at least one recommended wine on a display interface of the portable electronic device.

### RELATED APPLICATIONS

This application claims the benefit of the priority date of U.S. Application 61/506,797, filed on Jul. 12, 2011, the contents of which are herein incorporated by reference.

### FIELD OF DISCLOSURE

This disclosure relates to the wine industry, and in particular, to methods and systems for wine selection.

### BACKGROUND

As a result of improvements in mass production, individual samples of goods are fairly uniform in quality. This has made it possible to reliably predict quality based on the manufacturer and trade name of a good. This uniformity extends even to the food and beverage industry. In general, one has a reasonable expectation that a particular brand of beer or distilled spirit will have a particular taste.

A patron at a restaurant who wishes to order beer or a distilled beverage thus does not have an overwhelming task. A typical beer list or spirit list in a restaurant consists of a relatively small number of well-known brands whose tastes are fairly predictable and stable.

In contrast, a typical wine list has a great many entries. Variations in taste, and in price, are large. And to make matters worse, both taste and price vary from year to year in an unpredictable way. For many restaurant patrons, choosing from a wine menu is something of a gamble.

Recommendation engines have become common for many goods. However, such recommendation engines are often impractical for use in a restaurant setting, much less for recommending wines. The inventory of wines available to choose from is unpredictable, and varies markedly from one restaurant to the next. In a social setting such as dinner at a fine restaurant, decisions on such matters as wine cannot be made at leisure. Yet, a flawed decision can result in a dinner that is memorable for all the wrong reasons.

### SUMMARY

The invention provides a method and system for recommending a wine based on dynamically varying constraints. These constraints begin with the wines available at a particular restaurant. Additional constraints include the food to be paired with the wine, the preferred variety of grape, country of origin, wine color, and the like. For each set of constraints, a set of recommended wines is provided. In some cases, the selection is based in part on feedback from the user or other users.

In one aspect, the invention features a computer program product, tangibly embodied on a computer readable medium, that includes instructions, which when executed by a data processor of a portable electronic device, cause the data processor to obtain a list of wines available at a commercial establishment and identify at least one attribute associated with each wine included on the list of wines. The instructions further cause the data processor to, for each wine included on the list of wines, determine a score indicative of a likelihood that the user will purchase the wine on the basis of the at least one attribute and at least one of a characteristic associated with the user and a preference input by the user. The instructions still further cause the data processor to, based on the score, identify at least one recommended wine for recommendation to the user; and present the at least one recommended wine on a display interface of the portable electronic device.

In some embodiments, obtaining the list of wines includes receiving an image of a menu and processing the image to obtain the list of wines. In others, obtaining the list includes receiving text and processing the text to obtain the list of wines.

Also among the embodiments are those in which obtaining the list of wines includes identifying the commercial establishment and retrieving an electronic representation of the list of wines from a wine list database. In some of these embodiments, identifying the commercial establishment includes at least one of receiving an input from the user identifying the commercial establishment and identifying the commercial establishment based on a GPS signal indicative of a location of the portable electronic device.

In other embodiments, obtaining the list of wines further includes: receiving an image of a menu; processing the image to obtain an image-derived list of wines; and comparing the image-derived list of wines with the electronic representation of the list of wines.

The attribute includes at least one of a professional rating of the wine, a numerical rating of wine; a peer group ranking of the wine with and without heuristic filtering; a food sciences based ranking of at least one characteristic of the wine; and a description associated with the wine tagging such as “fruity” or “big” to enable more refinement and segmentation profiling.

Embodiments include those in which identifying at least one attribute includes, for each wine: determining an identifier of the wine based on information included in the list of wines; and retrieving, from a wine attribute database, the at least one attribute associated with the identifier of the wine. For example, the information included in the list of wines includes at least one of a variety, a year, a winery, a location, and a price.

Embodiments differ in the preferences that a user might input. In general, there exist embodiments that receive any combination of one or more of the following: a price range, a maximum price, a preferred wine color, a preferred variety, a preferred attribute, a preferred wine style, a preferred wine source, and a preferred food-wine pairing.

Embodiments also differ in the user characteristics relied upon to select a wine. The characteristic associated with the user can include any combination of one or more of the following: a history of wine purchases, a history of wine ratings, and a history of wine pairings, i.e. pairings between wine and food, and a rating of at least one of the wines included on the list of wines by another user connected via a social network to the user.

The instructions further cause the data processor to prompt the user to provide feedback associated with the recommended wine. Feedback associated with the recommended wine includes at least one of whether the user purchased the recommended wine and a rating of the recommended wine.

In some embodiments, the commercial establishment includes at least one of a restaurant and a bar.

In another aspect, the invention features a system for recommending a wine to a user. Such a system includes a wine list module configured to obtain a list of wines available at a commercial establishment; a wine identification module configured to identify at least one attribute associated with each wine included on the list of wines; a scoring module configured to, for each wine included on the list of wines, determine a score indicative of a likelihood that the user will purchase the wine, for example for the user, or for the user's friends, on the basis of the at least one attribute and at least one of a characteristic associated with the user and a preference input by the user; a recommendation generation module configured to identify, based on the score, at least one recommended wine for recommendation to the user; and a presentation module configured to present the at least one recommended wine on a user interface of a portable electronic device.

The wine recommendation system and methods described herein have a number of advantages. The wine recommendation system is a mobile tool designed to enhance and expand a person's ability to select a satisfying wine even under circumstances that include incomplete knowledge accompanied by time pressure in a social setting. For instance, at a high-pressure business dinner, a sales team leader may be uncomfortable selecting a wine in front of potential clients. The situation is made more stressful by the knowledge that the waiter will soon return, expecting a selection to have been made. The use of the wine recommendation system described herein can unobtrusively assist with the selection of wine based on price, taste, and other preferences or history.

From a business perspective, the wine recommendation system helps leverage impulse purchases by allowing customers to order wines they have recently tried. Auctions, coupons, and other marketing strategies can be used by distributors, retailers, or wineries to attempt to sway a consumer's wine choice in real time.

Other features and advantages of the invention are apparent from the following description and from the claims, and the accompanying figures, in which:

### BRIEF DESCRIPTION OF DRAWINGS

FIG. 1 is a block diagram showing the components of a wine recommendation system;

FIG. 2 is a sequence diagram illustrating the user workflow of the optical character recognition (OCR) application of the wine recommendation system;

FIG. 3 is an entity diagram that depicts the primary entities in the architecture of the wine recommendation system; and

FIGS. 4A-4D are block diagrams of exemplary recommendation engines used in the wine recommendation system.

### DETAILED DESCRIPTION

### Overview

A customer dining at a fine dining restaurant is confronted with a menu and, generally, a large wine list. This wine list can be overwhelming for even a seasoned oenophile. In such cases, a customer often relies on a recommendation by a waiter or sommelier. However, even a waiter or sommelier may not be familiar with more than a handful of the available wines. Nor will a waiter be familiar with the customer's preferences or his wine drinking habits. Given the time pressure on a sommelier, it is often not practical to have an extended discussion about more than a few wines on the menu. Moreover, a sommelier or waiter has an interest in maximizing revenue and/or moving inventory. Thus, it may not always be prudent to rely exclusively on their recommendations.

The wine recommendation system described herein provides a way to begin with a set of wines available in the restaurant and to whittle down that set by imposing constraints. Based on these constraints, the system communicates a set of one or more wines to the user's mobile device, which can be a smart phone or a tablet computer.

A variety of pieces of information are returned, including metadata from the wine recommendation system, detailed information about the wine, other accolades about the wine, price, whether the customer has had the wine before and other relevant features. This information gives the customer adequate information to make a decision in real-time at the restaurant. After selecting and tasting the wine, the user rates the wine. The choice and rating are tagged to the user's profile in the wine recommendation system for later use and optionally published to social networks of the user's choice. The choice of wine, publishing methods, and content creation are all factors in an algorithm for generation of reward points that can be redeemed for virtual and tangible rewards. Like an attentive sommelier, the wine recommendation system checks back with the customer later to invite the customer to order the same wine for home delivery.

The wine recommendation system offers a user interface on a smart phone that provides a list of restaurants that are compatible with the system. One can either type in a restaurant or rely on the smart phone to use a global positioning system (“GPS”) signal to display nearby restaurants that are compatible with the wine recommendation system.

After selecting a restaurant, the user interface invites the customer to impose constraints on the selection. Such constraints might include a preferred grape, a preferred country of origin, an indication of what food is to be paired with the wine, and constraints on price.

The smart phone communicates with a central server in communication with a central database. The server then executes a recommendation algorithm for recommending wines subject to the constraints specified. It then transmits the set of recommended wines back to the smart phone for presentation to the user.

The selection of an appropriate wine to go with a particular meal quickly results in a combinatorial explosion. There are over fifty food groups and over eighty flavors in a wine. There are approximately two hundred thousand kinds of wine in a given year. For simplicity we can assume only ten different years. However the life cycle of a wine must be considered. This life cycle includes three stages, not ready, ready, and past its prime. To this is added a ratings that divides wines among some number of classes, which for simplicity is assumed to be five. This results in 120 billion combinations.

The combinations described above define a multi-dimensional abstract wine space. Each user tends to favor a portion of this space at any time. As the user's palette matures, this favored portion tends to change over time. Thus, for each user there exists a trajectory through this wine space that reflects that user's evolving habits. This trajectory, which is likely to be unique for a user, is referred to as the user's “VinPrint.” Knowledge of a user's favored portion of wine space at any time is useful for predicting what wines that user might like at that time. Knowledge of the trajectory of this favored portion over time, or the VinPrint, provides a basis for predicting what the user may want to drink in the future. Knowledge of the VinPrint of an aggregate of users would thus be useful for predicting what many users may want to drink in the future. This information is particularly useful for wineries and other wine production facilities that may wish to meet those wine drinking needs in the future.

A machine learning module can be used to create, revise and track these trajectories, or “VinPrints” for various users, either individually, or in aggregate. Such a machine learning module can also be used to build a persona. As used herein, a persona can include an actual person or a synthetic person that represents a composite or aggregate of multiple consumers.

The wine recommendation system provides a number of operational features.

Among the features is the ability to retrieve a wine list from a restaurant and return information about chosen wines (meta-data) plus other reviews and information. Retrieval can be carried out directly, by reading a posted file, or indirectly, by imaging a picture of a wine list and performing optical character recognition. Recommendations are provided as a function of the app user's wine recommendation system profile settings, and in some cases, social network settings.

Another feature is the ability to provide reviews of selected wines. These can range from detailed reviews, reviews that rely on a numerical rating, or a binary review, in which the wine is either rated as good or bad. Related to this feature is a wish-list, in which are stored wines that are to be sampled when opportunity presents itself, photographs, to assist in identifying wines, and other meta-data.

Another feature is a journaling interface in which the user can save notes and comments on subject matter such as tasting, the venue, and the overall food experience associated with a particular wine.

Another feature is barrel list, or bucket list. This is similar to a wish list and is intended to contain a list of things to do or experience before a deadline, whether self-imposed or externally imposed. Such a list can be public, or can be made private to varying degrees to selected people, or it can be made anonymous.

Another feature is a wine hunter or sommelier that functions as a personal shopper to hunt down particular wines that are consistent with a user's profile.

Yet another feature is a scoreboard on which can be displayed points that have been earned and that are to be redeemed. Points can be earned by any one or more of a variety of activities, including voting on barrel lists, photography and/or video contests, and the value of ratings or information provided by a user. By providing a reward point system, the system promotes deeper engagement with a community of users.

There are three profile components in the system: a user account, a social network, and a wine recommendation system's wine profile. Software in the form of an app provides a set up area for adding social network profiles, and for tying profiles to walls.

The wine profile consists of three engagement levels ranging from basic, through anonymous, to full enrollment and disclosure. The engagement level determines an extent to which an app can assist in the user's wine selection experience.

In addition, the system supports push notification functionality to add information to a user's wine recommendation system profile. For instance, a user may complete missing information; expand existing informationbased upon other criteria used by recommendation engine; or validate differences between observed behavior and the profile. In some cases, a poll-of-the-week approach is used to collect data for public sharing in a format similar to that found in newspapers. The push notification functionality is also usable for communicating educational information or third party messages, information on a particular vintage year, information concerning wines from a particular region, or pairing suggestions for pairing wine and food.

In some cases, the wine recommendation system is capable of operating in other languages, such as Spanish, French, Italian and Chinese.

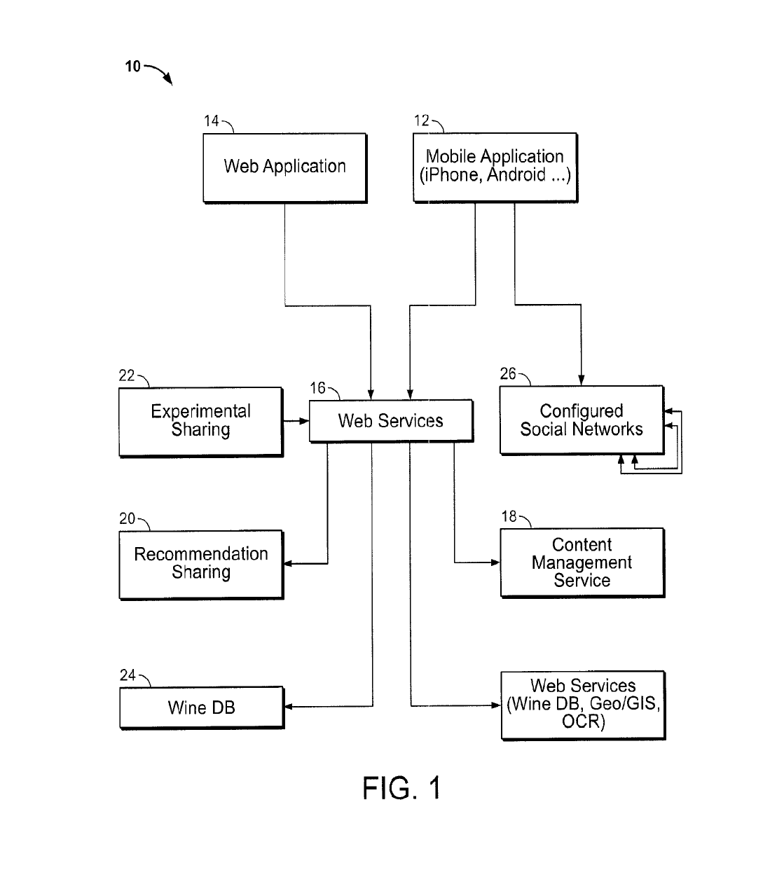

Referring to FIG. 1, the wine recommendation system 10 includes a mobile application 12 (“app”), a web application 14, and a web services component 16.

The web application 14 represents the home page for the wine recommendation system 10 and includes basic information on the wine recommendation system 10. Such information includes an “activity fall,” which is an animated stream of activity occurring on the wine recommendation system 10, and links and/or instructions on installing the mobile application 12. The web application 14 provides customer support infrastructure for users of the mobile application 12 and also provides a convenient way to receive feedback. Such feedback can include suggestions, enhancement requests, bug reports, and comments. The web application 14 also provides administrative functions for the wine recommendation system's team to manage wine recommendations and meta data, to monitor activity, to collect business intelligence, and to perform other administrative tasks. The web application 14 also provides infrastructure to support additional business streams such as events, and products and services, and to support wine procurement.

The mobile application 12 is the “face” of the service. As such, it is the primary component that the user comes in direct contact with. A secondary contact can be in the form of a web interface on a computer or on a display mounted to another device or object, such as a refrigerator, or a wall in a wine cellar.

The web services component 16 includes a server-based set of application program interfaces (“API's”) used to power the mobile application 12. Some of the functions provided by the web service component 16 include user profile aggregation, wine list recommendations, wine meta data assimilation, social graph activity, proxied location-based service (“LBS”), and optical character recognition (“OCR”), and other data retrieval services.

Additional functions provided by the web services component 16 include a content management system 18, a recommendation engine 20, and experiential sharing infrastructure 22.

The content management system 18 supports the restaurants in which the user experience occurs. This component provides a scalable database 24 containing descriptions of the restaurant, its wine list, and photographs and videos related to the user experience at that restaurant. The content management system 18 provides mechanisms to API's for extracting information for use by the recommendation engine 20 and a mechanism to create and curate the information. The database 24 should be reasonably large. In one embodiment, the database 24 supports on the order of 15,000 restaurants in North America. However, the database 24 is expected to support on the order of 250,000 restaurants in North America and 500,000 globally.

The recommendation engine 20 is based upon a rules-driven system that uses information about the current wine offerings at a restaurant, the user's profile, which is a function of a user-chosen setting, food, budget, and other factors. Based on all these factors, the recommendation engine 20 offers a ranked set of recommendations. In some cases, the recommendation engine 20 takes into account feedback provided by other users who have already dined at the restaurant in question and who have similar profiles.

The enjoyment of wine includes not just the taste and aroma of the wine itself, but also the setting in which it is consumed, the friends with which it is consumed, and the nature of the event itself. For example, the overall experience of drinking champagne at a wedding is often quite different from drinking the same champagne at a funeral. The experiential sharing infrastructure 22 enables sights and sounds associated with the wine-enjoyment experience to be recorded and facilitates upload of the resulting videos and photographs. The experiential sharing infrastructure 22 provides various social network sites as target destinations. Examples of social network sites are those operated by AFFLUENCE, FACEBOOK, TWITTER and YOUTUBE. Additional social networks can be supported as target destinations by providing suitable APIs. However, users of the wine recommendation system 10 may seek to have such information associated directly with other targets, including their account on the wine recommendation system 10.

As shown in FIG. 1, the wine recommendation system 10 further includes configured social networks 26 that represent a user's sharing preferences as configured in the mobile application 12. Examples of social networks that can be supported include AFFLUENCE, FACEBOOK, TWITTER, LINKEDIN, and FOURSQUARE, and A SMALL WORLD. A pluggable approach is used so that additional networks can be added based on popularity, user demand, and business development activities.

### Mobile Application

The mobile application 12 is the user interface for the wine recommendation system 10. The mobile application 12 communicates with a back-end using a collection of web-services (or application programming interfaces (APIs)), described in greater detail below.

Those users of the mobile application 12 who have an account on the wine recommendation system 10 belong to a user community. These users are able to login to their favorite social networking sites with a single login. This feature is accomplished based upon OAuth or a similar approach.

After account setup, the following usage model is carried out when a wine recommendation is sought at a restaurant:

First, a location-based service is used to verify the name and location of the restaurant. Then an alert or equivalent is presented to confirm the restaurant's name and location. On those occasions in which the location-based service fails to identify a single unique restaurant, a list of multiple restaurants is presented, and the user is invited to select an appropriate one.

The restaurant's name is passed to the wine recommendation system's servers to determine if the restaurant's wine list is in the wine recommendation system's databases. If not, a message is returned. In some cases, the message may include a solicitation inviting the user to suggest to the restaurateur that participation in the network be considered.

If information about the restaurant is included in the wine recommendation system's databases, the user is prompted to provide constraints useful for identifying a suitable wine selection.

The user of the wine recommendation system 10 will be asked to indicate preferences for a type of wine, including, for example, red, white, and rosé. The user may also be invited to provide a price range, to provide preferences for a source of wine, such as Argentinean wine, or wines from upstate New York. In some cases, the user may express a preference for local wines, in which case knowledge of the restaurant's location can be used to identify a suitable selection. The user may also be invited to identify preferred vineyards. In some cases, the user will be asked to identify the food that is to be served with the wine, to assist in recommending suitable wine/food pairings. Or the user may be asked to identify preferred wine/food pairings.

The foregoing parameters, restaurant name, device information, and location-based service information are passed to the wine recommendation system's servers. There, they are used to form database queries on the server and to obtain and filter data from the wine database via wine database API's.

Following a pre-defined period after the user selects a wine, the user will receive a push notification via a third party system, such as Flury, Urban Airship, or a multi-platform equivalent. This push notification solicits the user's views on the wine. The user may be asked, for example whether he liked or disliked the selected wine. If the user indicates that he liked the wine, the system may offer the user an opportunity to purchase additional bottles of the wine for domestic consumption, and to identify a suitable location for purchase or provide a link to a suitable web-site for on-line purchase.

The mobile application 12 begins with a sign-in or sign-up screen. Upon passing through this screen, the user is presented with a home screen offering a “Profile” button, a “Friends” button, a “Feeds” button, a “Recommendations” button, a “Settings” button, and a “Games” button.

The “Profile” button provides a user interface for viewing or changing such items as one's name, profile image, and bio, any statistics, reward points, and status thereof, the ability to edit one's profile, and the ability to enter information for journaling one's wine-related experiences.

The “Friends” button provides an interface that lists friends and that enables addition of friends, either through issuing an invitation, or through approval of invitations from others.

The “Feeds” button provides an interface for managing public feeds, feeds from friends, or feeds from nearby locations.

The “Recommendations” button provides an interface for scanning a wine list, viewing recommendations, selecting wines, and creating a journal entry concerning wines, as well as a way to share such information.

The “Journaling” button provides a user interface for documenting one's experience with wine. This includes a journaling history, a search engine for enabling extraction of keywords related to wines for refining wine recommendations, for creating journal entries, for tagging other users, for rating and scoring wines and wine pairings, and for particular wines, and for organizing photographs, videos, audio, and results of voice-to-text conversion into records.

The “Settings” button provides a user interface for controlling sharing preferences, for providing feedback and for rating the application itself, information identifying software version, authors, and contact information, and information concerning connected networks.

The “Games” button provides an interface for games such as games related to wines. These may include, for example, trivia games concerning wine, or games in which one attempts to match one's selection against those provided by the recommendation engine 20. In some cases, winning such a game may be used to provide reward points that can then be redeemed.

### Functional Components

The following sections describe the functional components listed above in more detail.

### Sign In/Sign Up

Whether signing up or signing in using a social account or traditional wine recommendation system account, all connections are connected to the same logical user profile. For example, if a user initially creates his wine recommendation system profile using AFFLUENCE or FACEBOOK Connect and then later signs in using FOURSQUARE, both social accounts connect to the same logical wine recommendation system profile. It is assumed that users create a profile to use the application and therefore the sign in/sign up view is a gating function for the rest of the application.

Because the wine recommendation system 10 uses data mining and business intelligence methods to help the user find a suitable wine and to build a user profile and wine purchasing history, each user account is associated with the following: a User ID, a first name, a family name, a date on which the user joined the user community, a birthday, home geography, a language, email contact information, text contact information, permission settings for contacting, permission settings for receiving marketing materials, a link to a personal wine profile, a link to a shareable wish list, a link to personal shopping cart, mobile application data for analytics, linkage to one or more social networks, and linkage to blogs and comment interfaces.

A social connector interface enables users to setup their profile using their existing social accounts, such as AFFLUENCE, FACEBOOK Connect, or TWITTER. The respective OAuth model is used so that authentication tokens can be used to cross-post and check-in on those services. Content describing the wine recommendation system 10 or providing access to a sub-view through which the user can learn more about the wine recommendation system 10 before signing up may also be provided on this view.

### Home View (Existing User)

Once signed in, the Home view is the view from which all other functions are accessed. The Home view may be an icon-style home page similar to that used by AFFLUENCE, FACEBOOK and SCVNGR mobile applications.

### Profile

The Profile view displays information about a user, his activity on the wine recommendation system 10, and statistics derived from his activity and relationships on wine recommendation system (i.e. scoreboard). A current user viewing his own profile has access for editing his profile details. Several statistics can be tracked for each user.

The user can set his image profile using either an image (e.g., a photograph or an avatar) on his phone or via his phone's camera.

The user can enter his first and last name. To other users, the user is referred to by his first name and an initial of his last name (i.e. “James J.”). Optionally, the user can define a unique user name and choose to be referred to by that name. This permits selective anonymity.

The user can enter a short (e.g., around 250 characters) bio for his profile.

The user can sign out from the wine recommendation system mobile application 12 from the profile view.

### Settings

The Settings view is where the user controls his social connections, preferences, and has access to application meta-data and feedback.

A Social Connections view is where the user makes his connections to supported social networks, including AFFLUENCE, FACEBOOK, TWITTER, or A SMALL WORLD.

Sharing preferences control the default network visibility of the current user's activities in the wine recommendation system. Activities are either private, shared with friends only, or shared with the entire wine recommendation community. In some cases, the wine recommendation system product is available to international users. As a result, so the software and databases allow for the architectural implications of privacy controls outside the United States. The user can specify whether check-ins on the wine recommendation system should be cross-posted (by default) on other location-based services such as FOURSQUARE and FACEBOOK Places. These settings can be overridden when checking-in or journaling.

An informational view describing the wine recommendation system and providing the application's privacy policy can also be linked here.

Users are given an opportunity to submit feedback on the application. In some embodiments, this function opens a view for composition of email. In other embodiments, the application includes a mechanism that invites the application user to provide feedback after several sessions.

### Friends

This view allows the user to view and manage his list of friends within the user community.

The user can manage friends, including reviewing the current list of friends and managing friend requests, for example, by approving or denying friend requests. The user can also invite friends, which allows the user to connect with friends on connected social networks who are already members of the wine recommendation community as well as to invite friends from his networks or contact list to join the wine recommendation system.

### Friends Feed

This view allows a user to view his friends' activity on the wine recommendation system. The view can toggle between his friend feed and the public view. The user is given the ability to “Like” and to comment on other user activities in his friend feed or the public feed.

### Nearby

This view shows friend or public activity near the user's current location, ordered by location. As was the case withto the friend feed, the user is given the option to switch to nearby activity of his friends and public nearby activity.

### Check-In

This view allows a user to check-in to a location by activating a match between a restaurant and a wine list recommendation without OCR or by initiating the wine recommendation process via the OCR. Check-in activities will appear in the user's activity feed and will be visible to friends and on the public feed based on the user's sharing preferences. Check-ins may also be cross-posted to other location-based services based on sharing preferences. But these can be overridden for each check-in. This allows the user to setup his default sharing behavior but to nevertheless override this behavior for specific check-ins as desired.

When the user initiates the check-in process, a Locate and Check-In API causes a list of nearby locations to be displayed. For locations not in the recommendation system's database, a third party service such as the Google Places API or FOURSQUARE Venues API may be used to find nearby places. If SimpleGeo integration is utilized for overlaying geo meta data associated with the wine recommendation system, then the SimpleGeo API may be used here as well. A multi-check-in feature may also be implemented. In an alternative embodiment, all check-ins are proxied through the wine recommendation system API so that any changes to third party APIs can be quickly changed in one place without the need for updating the mobile application 12.

Check-ins are provided to the wine recommendation system API. If the user chooses to cross-post his check-in to a third party check-in service (i.e. FOURSQUARE or FACEBOOK Places), the check-in is performed directly with that service. In an alternative embodiment, all check-ins are proxied through the wine recommendation system API so that any changes to third party APIs can be quickly changed in one place without requiring the mobile application 12 to be updated.

In some cases, a “Wine List Assistant” (i.e. OCR workflow), “Journal” (see below), and others present at check-in (other wine recommendation system users, friends from social network connections, or the phone's address book) may be included on the check-in page.

### Wine List Assistant (Photograph/Search)

If the user selects the Wine List Assistant, the user's phone's camera is activated so the user can take a photograph of a wine list page. Access to helpful tips is available through this view. for example via toolbar icon or screen overlay to educate the user on how to take the best photographs possible for the optical character recognition (OCR) process. For example, the user might be told to hold a camera perpendicular to the wine list, to take a picture of all or the portion of the wine list of interest, to hold camera still, to use caution in using flash in restaurant settings, and so on.

As an alternative to finding wines by photographing the wine list, the user may also be given a search-by-name option. Searching is performed through the wine recommendation system API, which proxies to the recommendation system's wine database API, so that recommendations and friend activity can be incorporated into the results. Search by name is also available in the Journaling feature.

If an in-application OCR engine is integrated into the wine recommendation system, the photograph is sent through the OCR engine once the user taps the shutter button. The output from the OCR engine is tested for minimal acceptable output. If the output passes this test, the OCR text is sent to the wine recommendation system web service along with user and location information. The wine recommendation system web service is described in detail in the web service section below.

If OCR functionality is implemented by the recommendation system's web service, the photograph is resized and submitted to the wine recommendation system web service along with user and location information.

The response from the wine recommendation system web service includes a list of wines detected from the wine list scan along with recommendations for those wines and, in some cases, pricing information. If no wines were matched, the user is directed to the search-by-name option and given the ability to enter the wine name.

### Journaling

Journaling represents a user's interaction with a wine. The journaling event includes the wine itself, a rating or score for that wine, free-form text, references to other people at the journaling event, including both members and non-members of the wine recommendation community, photographs of the journaling event, such as photographs of the wine bottle, of other people at event, of the food itself, and of the table decorations, and the location of the journaling event. When initiating a journaling action from a check-in, some information can be passed from the check-in activity such as the location of the event, names of people present at that event, and selected wines served at that event.

If the journaling action is initiated from the Home view (i.e. a wine is not passed from a Check-In action), the user is given the option to search for the wine by name and/or to enter the wine by name. The recommendation system's wine database API can be used to provide the wine search or this can be proxied through a wine recommendation system wine search API to overlay recommendations and meta-data.

A user of the wine recommendation system can tag users present at the journaling event. The users to be tagged can be from the user's wine recommendation system friends list, from his social network connections, for example his social network friends, or from his phone's address book. Alternatively, the users can be entered free-form.

The user can also associate multiple photographs with the journaling event. Photos can be of the wine bottle, other people present at the journaling event, food, or other subjects. A practical limit on the number of photographs may be dictated by the user interface design. A user may be offered the choice of whether to store photographs in his camera roll. This can reduce the clutter added to his camera roll while still permiting him to access the photographs from the activities (i.e. stored with activity in the wine recommendation system).

### Compliance Module

Many jurisdictions have limitations on shipping wines. The recommendation system described herein offers the ability to purchase wines directly and to have them shipped to a particular address. In some implementations, a compliance module identifies the location to which the wine is to be shipped and determines whether a shipment to that location would be compliant with local law. In the event such shipment would be non-compliant, the transaction will be refused.

Jurisdictions also typically impose lower limits on the age at which a person may purchase alcohol. In one implementation, the system features a biometric module that determines whether or not the purchaser is of legal age. Such a module may operate by asking the purchaser to provide an acoustic signal into a microphone, which would then be analyzed to determine whether the sale would be compliant with law. Alternatively, the purchaser could be asked to stand in front of the video camera found in many computers. An image is then collected from the video camera and analyzed for the same purpose.

### Analytics

In order to measure and evaluate the effectiveness of the application, analytics are captured during usage of the application. Analytics include click/tap paths, popular application features, and general usage tracking (i.e. time of day). Analytics data are collected and submitted to the wine recommendation system web services API as “out of band data” when API requests are made during the normal course of application usage (i.e. piggybacking on API requests).

### OCR

Optical character recognition (OCR) capabilities can improve the wine recommendation system user's restaurant experience. OCR is implemented on the server side. As a result, the wine recommendation system mobile application transmits user-generated wine list photographs to the recommendation system's server along with location-based service, restaurant and device information. In one example, the wine recommendation system is hosted in Amazon EC2 instance(s) and accesses the ABBYY OCR engine in separate EC2 instance(s). This approach employs the best-in-class ABBYY OCR engine, utilizes the SaaS model for OCR, and mitigates wine recommendation system-to-ABBYY latency since the wine recommendation system would connect to the ABBYY instance(s) over LAN connections.

In some cases, in order to provide sufficiently consistent results, only smart phones with cameras having a minimum of 3 mega pixels are supported.

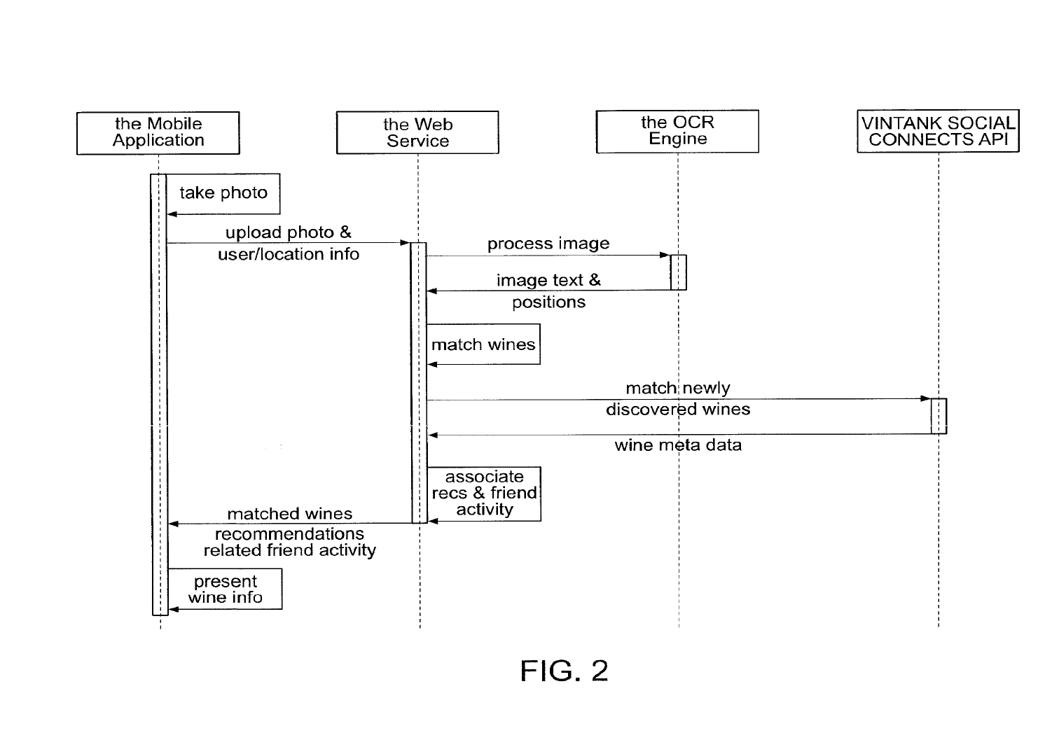

FIG. 2 illustrates the general user workflow of the OCR-related application tasks with a server-side.

During development of OCR capabilities, the original photographs are kept with the associated device, date, time and relevant restaurant data for learning, product development and regression testing purposes. It is assumed that individual restaurants may generate multiple photographs of wine lists resulting from multiple users submitting photographs from different smart phones on different dates under varying conditions. This assumption is based upon incomplete restaurant wine databases in the wine recommendation system “cloud.” The photographs provided may not cover the entire wine list. Due to poor photography, only partial information may be extracted. In the case of multi-page wine lists, restaurant patrons may provide photographs for a few of the pages even if all photographs are completely usable.

The OCR solution will produce a searchable wine list database that will be linked to the restaurant. Some degree of version control will be required so that the restaurant database refers to the most recent and most complete wine list. As the OCR solution evolves, the photographs provided may be used to incrementally update the existing wine database rather than replacing it. This means that the OCR solution will search the existing database to identify the need to add new wines. Ultimately the lack of complete sets of photographs may require human intervention or more sophisticated daemons and administrative scripts to maintain an accurate wine database. Additionally, a database populated with photographs of the wine lists in restaurant settings can be used to verify the associated algorithms.

In some cases, the wine list of the restaurant is obtained, for example by accessing the website of a restaurant located where the user is located. In these cases, the OCR menu may be used for confirmation that the correct restaurant menu has been obtained. The OCR menu is therefore used as an optical verification of a database pull.

In other cases, the user is prompted to tell the wine recommendation system in advance that he has reservations at a certain restaurant to ensure that the wine list is available.

### Web Application

The web interface for the wine recommendation system includes two categories of pages: public pages and administrative pages. Web functionality is for usage outside of a restaurant setting and is not intended to imitate the experience of the mobile application. To enable mobile browser access to the wine recommendation system website and functionality, the architecture automatically supports platform friendly access. One approach is the “detect and redirect” approach. The mobile browser compatible access is for both the wine recommendation system account holder, a potential account holder, and for the administrative roles.

In one embodiment, the front-end web interface for the wine recommendation system is organized into a “home” page, a “login” page, an “about us” page, an “administration home” page, a “customer support” page, a “wine search” page, an “e-commerce” page, and an “events” page.

The “home” page provides a link to a login facility for enabling one to log into an account or create an account, to install a mobile application, to view an activity fall, to view information about the about the wine recommendation system, and to view its privacy policy and terms of use.

The “login” page invites the user to create an account, to log into an existing account, and to retrieve a lost password or reset a password.

The “about us” page is a static page with information about the wine recommendation system.

The “administration home” page provides for moderating user comments and feedback and administration of databases storing user profiles, user activity, OCR source images, activities, locations (i.e., restaurants), location activity, wines, OCR source images, and generation of reports.

The “customer support” page includes usage tips and allows wine recommendation system support staff to reply to user inquiries.

The “wine search” page, which is accessible to wine recommendation system account holders only, provides a way to find wine in the recommendation system's database by name search, provides wine selection filter criteria, places wines in a wine barrel, or wish list, and places wine into a shopping cart.

The “e-commerce” page and its associated infrastructure is accessible to wine recommendation system account holders only, and provides access to e-commerce services.

The “events” page, which is managed by a system administrator, allows user submission of events with moderation by an administrator.

In addition, the web interface supports synchronization of a user's wine recommendation account with the user's mobile application user profile, including synchronization of current settings, historical settings, and reports.

### Web Services/APIs

This section represents the “back-end” specifications of recommendation system and includes the APIs that will be used by the mobile application 12.

The “back-end” infrastructure of the wine recommendation system includes the application programming interfaces (APIs) that are used by the mobile application 12. These web services 16 include infrastructure for the wine recommendation system's databases, content management systems, and recommendation engines. In some instances, a server side implementation of OCR is also provided to retrieve wine menus. But in other embodiments, wine menus are retrieved as text.

Web services 16 are accessed using a RESTful interface over HTTP. However, RESTful is merely one of many possible communication protocols for client/server architectures. Accordingly, there exist embodiments that do not rely on RESTful.

The interchange format is JSON. However, JSON is merely one of many information exchange formats. Other information exchange formats include XML, ASCII text, and various databases. Accordingly, there exist embodiments that do not rely on JSON.

A simple authentication model is employed to validate that requests are coming from the mobile application 12. One such model includes passing a request-specific hash (computed with a shared secret), such as SHA-1, as a custom HTTP request header. A timestamp may also be incorporated to prevent replay attacks.

The web services module 16 provides instructions for consumption of information from the mobile platform provided directly by the user. Such information can include a restaurant's name and location, information resulting from a user's request to add a restaurant to the restaurant database, wine selection criteria, such as preferred color and price range, wine recommendation system login information, and journal content.

In some embodiments, it is possible to obtain information concerning wine-related activities of other users in the community of users. For example, the web services module 16 can provide information concerning what wines these users have ordered and what wine/food pairings they have made. This information can be segmented by class of user. For example one can view wine-related activity of users designated as friends, or one can view wine-related activity of other users in the community. In the latter case, one will not have access to the identities of the community members.

This information can also be segmented by location. For example, one can identify a particular restaurant and be provided with wine-related activities of other users in the community of users who have dined at that restaurant within some designated time window. Those activities can also be segmented by class of user. Thus, one can be informed of wine-related activities at a particular restaurant within a particular time-frame of users designated as friends and/or all users in the user community.

The web services module 16 also provides instructions for consumption of information from the mobile device created or produced by the application 12. Such information includes analytics, permission settings for contact preferences, such as adding a new restaurant, or changing a restaurant's location, and names of the social networks selected.

The web services module 16 also provides instructions for sending information from the server to the mobile platform. Such information includes wines filtered by recommendation engine 20, alerts that a selected wine can be purchased, together with quantity, pricing and shipping information relevant to such a purchase, database administration capabilities, user account administration capabilities, and an initial set of report generation “templates.”

Although a third-party clearinghouse of wine information, such as the VINTANK SOCIAL CONNECTS API or others, can be used to provide the wine search, the recommendation system can also include a wine database specifically created and maintained for the system. The wine recommendation system overlays the recommendations and metadata on the database using a wine recommendation system API.

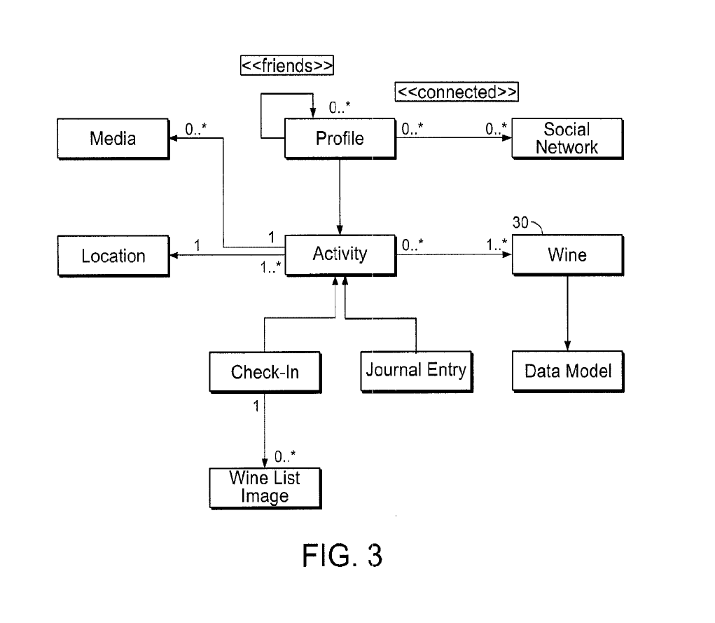

FIG. 3 is an entity diagram that depicts the primary entities in the wine recommendation system architecture and their relationships to each other. The wine recommendation system's recommendations and meta-data are captured in the wine entity 30. Various APIs are described in greater detail below:

### User Profile Management

A Get Profile API returns details for a wine recommendation system user profile based on the current/calling user's relationship with the requested user. The user's system name is always returned. If the calling user is a friend of or the same as the user being requested, the profile name, profile image URL, and profile statistics are returned. Profiles can be retrieved by UDID, email address, or by a connected network unique identifier (e.g. AFFLUENCE or FACEBOOK user ID).

An Authenticate Profile API is used to authenticate a user profile for a traditional account type sign in.

A Create Profile API creates a new user profile. For traditional accounts, the user's email address must be unique and therefore not already taken. Duplicate first and/or last names are allowed. A verification email is sent to users creating a traditional account. The email includes a link containing opaque details identifying the account to the Verification page in the web application 14 for automatic account verification. For accounts created using connected networks, the connected network and its unique identifier are specified. In all cases, the smart phone's UDID is included.

An Update Profile API updates an existing user profile. This includes passing connected network details. For instance, when a user connects via AFFLUENCE or FACEBOOK, the profile is updated to indicate it is now connected via AFFLUENCE or FACEBOOK and includes the user's AFFLUENCE or FACEBOOK user ID.

### Activities

Activities include check-in and journaling actions.

A Get Activities for Profile API returns the activities for a user profile in reverse chronological order. Activities can be filtered by type, for example by filtering out check-in or journal entries. For all requests, activities are filtered based on the calling user's relationship to the requested user as well as each activity's sharing settings.

A Get Friend Activities API returns all activities generated by friends of the calling user subject to enforcement of activity sharing settings for each activity. For example, if a user chooses not to share an activity with his friends then that activity does not appear in his friends' activities stream.

A Get Public Activities API returns all public activities.

A Get Nearby Activities API returns all nearby activities whether from friends or from publicly shared activities. Activities are ordered by their distance from the calling user's current location.

### Check-In

Check-in APIs record check-in activities for the calling user. If there are wines associated with the check-in, the activity, along with details of those wines, is forwarded to the recommendation system's wine database activity API. Multiple wines can be associated with a single check-in.

A Create Check-In API creates a new check-in activity.

An Update Check-In API updates a check-in activity. Updates occur when the user changes an aspect of the check-in after the initial check-in was created. For example, the user checks-in at a location and then selects a wine. A check-in update occurs after a wine is selected so that the wine can be associated with the check-in. Since multiple wines may be selected for the overall check-in over a period of time, for example as a result of consuming multiple bottles through the course of a long dinner, the same check-in is updated for each selected wine.

A Wine List Recommendations API is where photographs captured for OCR processing in the mobile application 12 are submitted for processing. This API captures the image from the request, submits it to the OCR engine, matches wines based on the OCR output to existing/local wine data and the wine database API, assimilates recommendations and rewards, looks up friend activities for the same wines, and returns the results. This API also supports searching for wines by name for direct journaling and when OCR results are not possible, for example because a user is unable to take photographs that yield usable OCR results. Wine pricing is also combined with the results here via calls to a wine pricing API. For repeat wines, pricing information can be cached in the system's data store to reduce the number of outbound API calls.

### Journaling

Journaling represents the user rating a wine and/or writing a tasting note for a wine. The wine could originate from a check-in or be unrelated to a check-in. Properties of journal entries can include author, date, sharing status, people, wine, notes, ratings, photographs, and locations.

The author entry identifies which user of the wine recommendation system created the entry.

The date entry is the date of the journal entry. This can be a current time from the mobile application 12 or it can be set explicitly by the user. In some cases, the date defaults to the current time.

The sharing entry flags whether the journal should be shared with everyone, with friends only, or with nobody at all, i.e. it is be kept private.

The wine entry identifies the wine that is the subject of the journal entry.

The people entry lists users present during the journaling event, which might be a dinner or a tasting event. People can be other wine recommendation system users, friends from social connections (i.e. an AFFLUENCE or FACEBOOK friend not using the wine recommendation system), or first names from the user's address book.

The notes entry provides a free-form tasting note in which the user can describe the wine with no restrictions on eloquence.

The ratings entry includes a more quantitative assessment of the wine, such as a rating, a score, or a scale. For example, the scale could be a binary scale, with score of 0 indicating that wine is disliked and a score of 1 indicating that the wine is liked. Or it could be an N-ary scale with a score being an integer between 0 and N selected by the user. For example, if N is 5, then the score is an integer between 0 and 5.

The photographs entry includes photographs and videos taken by the user to capture the journaling event.

The location entry identifies the physical location of journaling event. When journaling from a check-in activity, the location is the check-in location. Otherwise, the user can set the location using the same place's API as the check-in flow.

API's are provided for creating, updating, and deleting journal entries. These API's are respectively the Create Journal Entry API, the Update Journal Entry API, and the Delete Journal Entry API.

### Activity Reactions

Also available are API's for soliciting information concerning a user's preferences for an activity. In particular, a Like API allows a calling user to indicate a liking for an activity, and a Comment API allows a calling user to comment on an activity.

### Analytics Capture

The mobile application 12 captures analytics on the application's usage. This information is valuable in understanding how users are utilizing the application 12 and can shape the direction of future development.

The wine recommendation system captures the analytics data when the mobile application 12 uses the API for normal functionality. This can be achieved by designing all wine recommendation system API request formats to support optional “out of band” data that is unrelated to the specific request. This allows analytics data to be submitted to the wine recommendation system server by piggybacking on other requests. Out of band data can be journaled on the server for batch processing.

### Wine Recommendation Engine

The recommendation engine 20 is a rule based engine that uses queries, filters, and rules. The recommendation engine 20 evolves based upon various types of learning, including analytics, observations, experiments and analysis of customer feedback; and artificial intelligence style adaptive learning algorithms. The recommendation engine 20 includes functionality capable of extracting trends/clustering from individual accounts The recommendation engine 20 leverages eCommerce best practices, such as recognizing that people who purchased one thing also enjoy another.

In general, the wine recommendation engine 20 attempts to provide wine recommendations similar to recommendations that would be offered by a sommelier. Thus, the recommendation engine 20 inquires about whether the user prefers white, still, sparkling, or fortified wines, what the user commonly drinks, what the user proposed to eat with the wine, if anything, whether the user prefers wines that are fruity and rich or soft and subtle, whether the user prefers new world or old world wines, whether the user prefers traditional or modern styles of wines.

The recommendation engine also inquires about preferences of those with whom the user intends to share wine, where the wine is to be drunk, such as at home, at a party, at a restaurant, on a camping trip, at a hockey game, and the like. The recommendation engine 20 can also inquire about the occasion, such as whether the wine is to be drunk at a wedding, a baptism, or at an award ceremony.

The recommendation engine 20 may also inquire about the average price the user spends on a bottle, or a range of prices, the amount of purchase, whether by bottle or by case, the frequency of purchase, the average amount spent per purchase transaction, the average time between purchase and drinking of the wine, and whether the wine is to be stored in the cellar or is to be part of a wine collection. The recommendation engine 20 may also inquire about whether assistance is required when choosing your wine selection, whether the user prefers to have foreknowledge prior to purchase, or whether the user is prone to trust the expertise of others. The recommendation engine 20 may also inquire about whether the user purchases based on reviews, and if so, which publications or reviewers are found to be the most credible, whether the user travels to the locations at which his most favored wines are made, and whether the user typically experiments with choices or is conservative and prefers to drink within his comfort zone. Finally, the recommendation engine may inquire about the user's self-awareness on how developed his palate is, and may seek a quantitative measure, such as an integer between two values indicative of how knowledgeable the user regards himself in matters of wine tastemanship.

Information is extracted from postings to social network sites using keywords and algorithms. In some cases, the user provides initial declarations upon signup that the recommendation engine 20 can leverage, and these preferences are time stamped to be reviewed periodically. User preferences include price range of recent purchases; wines enjoyed usually with business colleagues versus wine enjoyed with friends and family; preferences between red, white, rose, champagne, dessert and port; the importance of pairing food with wine; a preferred geographic origin for the wine or preferred vineyards associated with a wain; names of recent wines enjoyed; whether or not the user is inclined to repeat previous choices or to explore new choices and thus develop his palette.

In some cases, recommendation engine 20 queries are extended by filtering using wine critic ratings and/or by filtering by optional food-wine pairing information. In some cases, the recommendation engine 20 includes pre-determined assumptions related to the pairing of wine with various ethnic cuisines or food preferences.

The success of the recommendations is tracked by verifying whether the user chooses one of the wines suggested in a first or second pass of recommendations and whether the ranking is indicative of the match quality.

In some cases, information is consumed prior to generating a wine recommendation. Such information includes information from a mobile user, from the mobile application 12, or from a browser. Examples of this information include static profile settings, a restaurant's wine list, meal category information, and budget and event specific preferences.

The information consumed prior to generating a wine recommendation can also be from server side and a third party. This can include wine records, restaurant records and historical user selection information.

Certain information is produced prior to generating the wine recommendation. Information returned to the mobile user, to the mobile application 12, and to the browser includes a list of top wine recommendations with corresponding descriptions. Information returned to server side databases would include queries and filters to the system's wine database, queries to the system's restaurant database, and queries to the system's user account.

Certain information is consumed after the wine recommendation from the mobile user, the application 12, or the browser. This includes the user's selection.

Certain information is also produced post wine recommendation. This includes an update to the wine selections associated with the user's account.

After the wine experience, certain information is consumed and produced. At the mobile user, the application 12, or browser, information is extracted from comments posted on social networks. In addition, pricing information is consumed. At the server side database, the user's account profile is updated based on his wine selection.

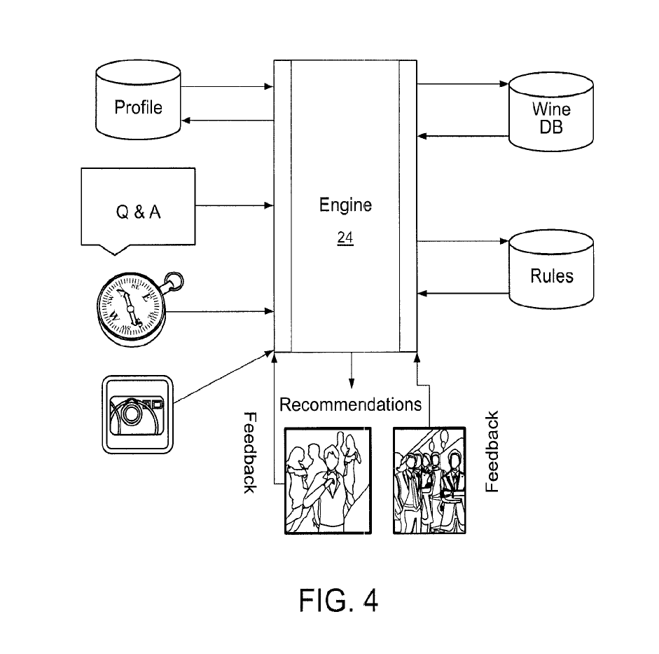

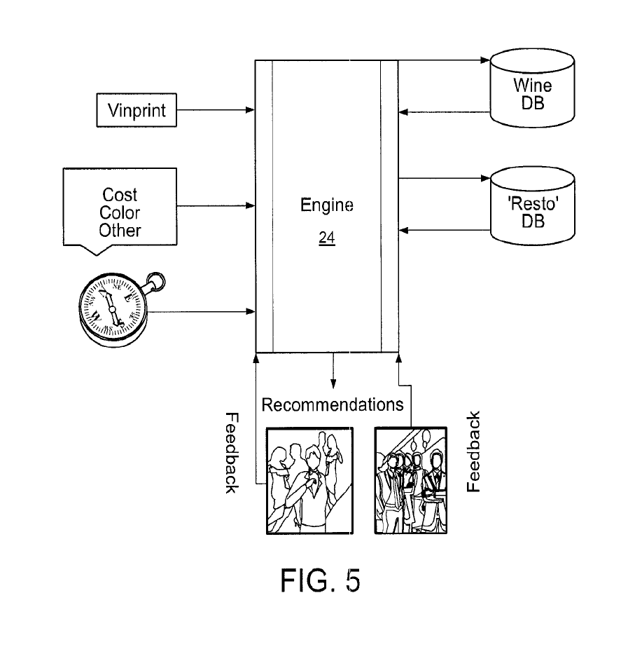

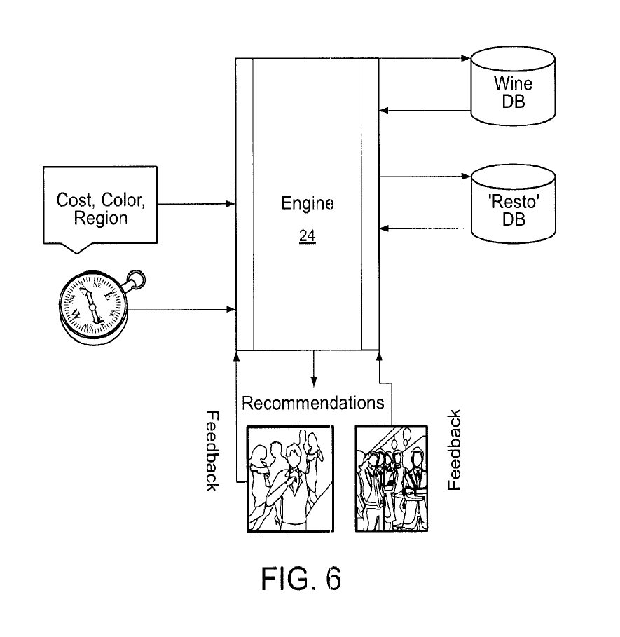

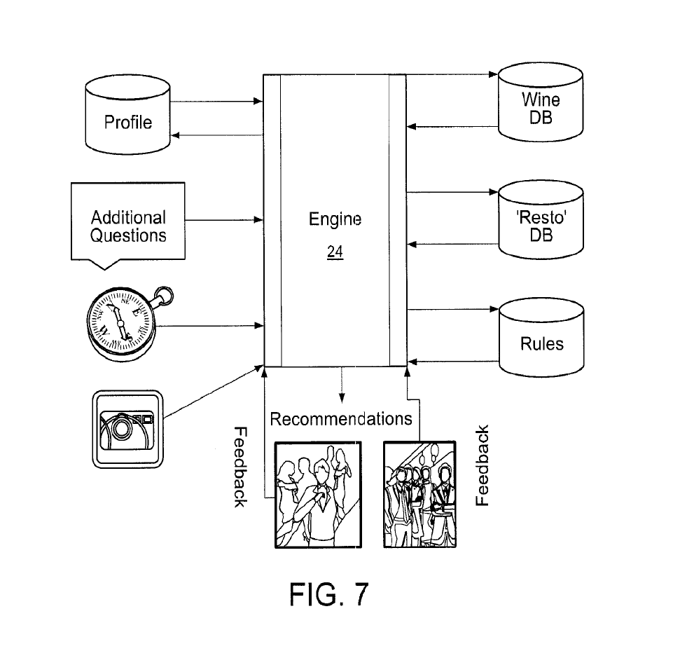

FIGS. 4A-D show schematic diagrams of wine recommendation engines.

### Databases and Data Model

A relational database (MySQL) is created and populated for restaurants and restaurant wine lists. Searchable wine lists are provided for this purpose. In some implementations, the server technology stack is LAMP or MAMP.

The following databases reside on the server: one or more proprietary databases on restaurants including complete wine list tables from OCR or from data retrieval, a Flurry Analytic database, a client data base based upon user name, an anonymous client data base based upon device UID only for additional analytics, one or more OCR databases, including uploaded photographs with location-based service tagging information, and a wine list database.

In general, the foregoing databases are relational databases such as MySQL. The system will leverage the infrastructure provided by the Social Networking sites for storage of photographs and videos.

The wine recommendation system's wine-list database has been defined in terms of database entities. The entities' attributes are used to uniquely describe a wine and to be referenced by related tables within the recommendation system's databases to store pricing information for BI purposes and availability at restaurants found through search and geo-location methods.

The restaurant wine list database attributes are as follows, on a per restaurant basis: the wine's name, whether the wine is a blended wine, the wine's vintage year, the data collection date, a location, such as country, state, and city, bottle size, current pricing, and a pricing history, which can include an array of key/value coding pairs indicating date and a corresponding price on that date.

A more general restaurant database includes attributes that describe the restaurant's location, hours of operation; the menu, the wine list, and OCR generated datasets extracted from the wine list. Additional wine attributes are associated with a restaurant. Examples of such attributes are preferred wines, attributes to improve the wine recommendation engine's value and digital signatures etc to assist OCR or other wine list ‘scanning’/digital acquisition methods are also included. Also available are restaurant reviews from a wine drinker's perspective.

A restaurant database may include the following attributes: name and biography of proprietors, address, contact information (telephone, fax, email, web URL), operation information, i.e. hours and days of operation, social network information, i.e.TWITTER name or AFFLUENCE or FACEBOOK reference, geographical information coordinates, i.e. latitude and longitude, current menus in PDF format, current wine list in PDF format, a link to OCR records, key words, a link to a restaurant specific wine database, wine related profiles, a link to ZAGAT or another trusted reviewing organization, a creation date, a last modified date, an indication of how current the wine list is and how much it has changed, wine reviews and selections, and links to third party wine databases such as VINTANK SOCIAL CONNECTS to supply the information listed below.

An OCR database includes the following attributes, on a per restaurant basis: sets of incoming photographs assuming multiple per person and multiple people per restaurant, a unique key for filing, for example, a combination of a device ID, date, and time, associated files resulting from OCR's processing of photographs, wine table information to provide for search of the VINTANK SOCIAL CONNECTS database, including name and year, status information to reflect validity of usage, a creation date and related information about OCR version and settings, a last modified date, some form of revision tracking or log, and identification information, such as the device platform, i.e. whether the device is an Apple, Android, Blackberry, Nokia, and Windows, the Device ID, the OS version, the date and time, GPS location information, and the restaurant name

In one embodiment, a wine list database recognizes sixteen major attributes, including a vintage, a region, a producer, a volume, an alcohol content. a varietal, a marketing designation, a classification, a vineyard designation, a brand, an appellation, a quality designation, a legal designation, an importer, a country, and a container designation.

In some embodiments, there is an indication of whether the wine is a blended variety or one having a defined vintage year. For implementation, a date attribute differs from a Boolean flag or text. As a result, in some embodiments, two or more attributes are used to indicate the vintage. However, in other embodiments, only one attribute is used.

For database administration, the system includes the ability to backup, clone, or restore the database, to edit a restaurant name, in case the restaurant changes its name, or its GPS location, in case the restaurant moves, to delete one or more wine tables for the restaurant, to add, delete, or modify uploaded photographs, to add, delete or edit uploaded device information, to add, delete, or edit version control of a wine table by, for example, aggregating multiple sources into one or more unique, usable database tables, to manage a connection of a wine table to a restaurant database by establishing or removing the connection, assuming that the restaurant database administration tools are able to change status of or purge the wine list.

eCommerce Support

Wine recommendation system mobile users may seek to purchase wine and wine related products. Therefore, the wine recommendation system mobile application 12 and website are configured to support shopping cart and purchasing infrastructure. This functionality is available to wine recommendation system users with either a wine recommendation system profile or a complete social network profile. This e-Commerce infrastructure enables additional wine recommendations during the shopping and check out process. The e-Commerce infrastructure provides information to the wine recommendation system about problems with shopping and abandonment rates.

The following information is collected in associated with ecommerce operation: supplier name, account number, discounts, contact information, billing address, bank account or wire transfer information, shipping address, and notes

In some embodiments, users of the wine recommendation system are presented with marketing offers in real time. For instance, coupons or other deals from wholesalers, distributors, or wineries may be offered in conjunction with the recommended wines in order to encourage the user to select a certain wine. Alternatively, in those jurisdictions where it is permissible, a reverse auction may occur in which a user states his parameters (e.g., a red wine under $100) and wholesalers bid for the user's purchase.

In another embodiment, the user can search for wines in two different ways: with a restaurant selected and with no restaurant selected. In the former, there may be hundreds of wines to choose from, whereas in the latter, there may be millions. As a result, it is useful to provide two distinct recommendation engines, one of which is optimized for restaurant based wine selection, and another for wine-selection in e-commerce.

In the former case, where the recommendation engine 20 is optimized for restaurants, a pre-selected number of wines is suggested unless the number of wines in the restaurant menu is less than the pre-selected number. In one embodiment, the pre-selected number is nine. The recommendation engine 20 also relies on a history of selected wines. These wines are rewarded with additional points. Wines that are ignored are penalized by a reduction in points. This enables the recommendation engine 20 to learn from a user's selections.

Each time a user requests a recommendation, the recommendation engine 20 has information concerning the user's preferences and prior history. Also provided is information concerning the identity of the restaurant, and various search parameters.

The input data also includes a price. Typically, the price is a tuple of two values, an interval and a currency. By default, the currency is set to US dollars. The interval is a tuple (min, max) that represents an initial price interval in which the recommendation engine 20 will search for wines. When the number of wines priced within the interval is insufficient to meet the minimum number of suggested wines, the interval is expanded until enough results are found. Default values for the first pair interval tuple and expansion tuples that follow are {(0,25), (26,50), (51,100), (101, 200), (201, 300), (301, 400), (401, 500), (501, none), (none, none)}.

Since the recommendation engine 20 also knows the minimum and maximum costs per bottle at a given restaurant, the set of possible tuples can adapt in response to the price range in a particular restaurant. In general, each restaurant will have six price intervals, or price bins. There are three different ways for calculating the endpoints of each price bin. One way is to divide the interval between the minimum and maximum prices for a given restaurant into six equal sub-intervals. Another way is to divide the interval into unequal sub-intervals, with the constraint that the number of wines in each sub-interval be the same. In a third method, only the upper bound of a price bin is changed, while the lower bound remains the same. In such a case, the bins need not be disjoint but can instead overlap to some extent. In this method, the upper bound can be incremented in fixed size steps, or the upper bound can be incremented in variable size steps subject to the constraint that a constant or approximately constant number of new wines will be introduced with each increment.

The input data also includes a color preference, which can take on three values: none, red, and white. If either red or white is selected, all suggested wines will have that color. An exception arises when the restaurant does not have enough wines of the selected color to meet the minimum number of suggestions. In that case, wines from the opposite color will be added to the end of the suggestion list once the wines of the preferred color have been exhausted. The case in which no color is selected is described below.

The input data also includes an array of strings “WineCategoryLabel(Foodpairing)”. The string is a concatenation of a wine style, a wine color, and a wine type. Wine styles include “still,” “sparkling,” and “sweet.” Wine types include “light,” “medium,” and “bold,” and wine color includes “red,” “white,” and “rose”). For example, one string might be the concatenation “SparklingLightWhite”. The values that this parameter holds depend on food category and dish selected in a search. For every dish selected the recommendation engine 20 provides three different values of WineCategoryLabel, a first choice, a second choice, and a third choice. If only a food category is selected, and not a specific dish, this array will have values of WineCategoryLabel for all dishes in the specified food category.

Another input to the recommendation engine 20 is a user-defined slider. The slider is a set of four slider elements, each of which corresponds to one recommendation source. These recommendation sources are friends, profile preferences, social networks, and wine critics. The value of each slider element defines an extent to which a recommendation from that source will matter. For example, a user who listens only to himself and nobody else might have a slider of (1, 0, 0, 0). A user who is prone to indecision because he listens to everyone equally will have a slider of (1, 1, 1, 1).

Another input parameter for controlling the suggestions is one that assigns influence to particular friends, rather than to categories. For example, given a set of friends, the user can specify whether that friend's recommendations will influence the recommendation engine's suggestions, and also whether recommendations offered by friends of that friend will influence the recommendation engine's suggestions.

User preferences can also be used as input for influencing the recommendation engine's suggestions. These parameters are learned by user survey answers or inferred from user history. The default value for each of these parameters is a null value. Examples of user preferences are preferred price, preferred countries of origin, avoided countries of origin, preferred regions, and preferred grape varieties.

Another available input parameter is a list of selected people, all of whom are other users of the wine recommendation system who also use social networks, and their corresponding wine selections.

Yet another available input parameter is a set of ratings by wine critics. In one embodiment, this consists of a first and second table. The first table includes wine ratings by wine critics that depend on country, region, grape, color, and vintage of wines. The second table lists wines and corresponding ratings by wine critics. For each wine, the rating is calculated by a weighted average of ratings by different wine critics collected from published sources. This particular input parameter is the same for all users of the wine recommendation system.

Also available as an input parameter for a particular user is a history of activity by that user. This history can include all search parameters and search results and thus provides information on the most selected wines, the most searched colors, the most ignored wines, the most preferred prices, and anything else that the user may have searched for. The history can also include information about restaurant statistics, such as the most searched meals, and the most selected wines in a particular restaurant.

In one embodiment, search history is stored after a recommendation engine 20 returns search results. The search history can be stored as a suggestion array of the form {id, user_id, timestamp, price, color, food_category, dish, wine1_id, wine2_id, . . . wineN_id}.

In another embodiment, search history includes suggestions that represent a user's reaction to search results. The reaction data includes a user's reaction to each of the wines identified in the suggestion array. This is stored in a reaction array of the form {user_ID, search_ID, wine1_status, wine2_status . . . wineN_status,} where the wine status for a particular wine is selected from the group consisting of “ignored,” “selected,” and “interested.” These are assigned to a particular wine by the user's activity. For example, if the user adds a wine to his wish list or bucket list, or if the user actually purchases the wine, then that wine the reaction value assigned to that wine is “selected.” If the user merely clicks on the wine to ask for more information about it, then the reaction value assigned to that wine is “interested.” On the other hand, if the user does neither, the reaction value assigned to that wine is “ignored.”

To the extent user preferences are stable, and to the extent tastes of those people specified in the slider do not change rapidly, serial visits to the same restaurant are likely to result in the same wine recommendations. The inclusion of history as described above prevents this from being the case, and permits the wine recommendation engine 20 to adaptively learn from the user's behavior.

Incrementing the rating of a wine that has been previously selected may cause it to appear higher in the ratings the next time the user visits that restaurant. For example, if a particular wine was returned as the seventh recommendation in one visit to that restaurant, and if the user selected that wine, then that wine may appear as a second or third recommendation on a subsequent visit to that restaurant.

Similarly, decrementing the rating of an ignored wine has the effect of eventually causing the wine to be removed from the recommendation list altogether. This means a new wine will have the opportunity to be on the list and to perhaps rise in response to user selection or interest. Thus, the system of incrementing and decrementing rating has the effect of acting like a pump that circulates wine suggestions and ensures that the recommendation list identifies wines that are most likely to be of interest to the user.

The recommendation engine 20 displays wines in order of descending recommendation rating. In one embodiment, there are 100 recommendation points that can be awarded to a wine. The actual score of a wine will depend on a combination of the values stored in the user's slider and any increments or decrements resulting from the user's history.

As an example of how a slider operates, consider a slider with values {0.27, 0.7, 0.4, 0.8}, where the first element, 0.27, corresponds to the slider value assigned to “friends.” The remaining three slider values are associated with user preferences, wine critics, and social networks. The sum of all the slider values would be 2.17. Thus, the “friends” slider represents 12.44% of that sum. Accordingly, the maximum number of points that can possibly be awarded by the user's friends is 12.44.

Suppose that the user has five friends from whom ratings are solicited. Assuming a binary rating system, for a particular wine, a friend can assign the wine a “1” if the wine is good and a “0” otherwise. If all five friends like a particular wine, then that wine will receive the full complement of 12.44 recommendation points from friends. If all five friends dislike the wine, then that wine will receive 0 points from friends. If two friends like the wine but three don't then that wine will receive 40% of the total available point value of 12.44, which would be 4.98 points. Similarly, if only one of the five friends liked the wine, then that wine would receive only 20% of the available 12.44 points, or 2.49 points.

The number of recommendation points corresponding to the social network slider value is awarded in the same way as the number of recommendation points awarded by the “friends” slider value.

The slider value for the user's preferences maps to recommendation points in a slightly different way. Suppose the preferences specify five constraints: a price interval, a favored set of countries of origin, a set of countries to be avoided, a set of favored regions of origin, and a favored set of grape varieties.

The maximum number of recommendation points available to be awarded as a result of satisfying all five user preferences is calculated by starting with the slider value for preferences. In this example, the slider is {0.27, 0.7, 0.4, 0.8}. The second value, 0.7, corresponds to the user preferences. Since 0.7 is 32.26% of the total of all slider values, the maximum number of recommendation points that can be awarded to a wine that complies with all user preferences is 32.26. Since there are five preferences, each preference is worth one fifth of 32.26 points, or 6.45 points.

The user preferences are now treated just the same way as friends in the preceding example. For instance, if the wine is in a preferred price interval, it will receive 6.45 points as a result of having satisfied the first user preference. If it is also from one of the countries in the set of favored countries, it will receive an additional 6.45 points for having satisfied the second user preference, in which case the total number of recommendation points would be twice 6.45. In general, the number of recommendation points awarded to a wine as a result of satisfying user preferences will be the product of the number of individual user preferences satisfied and the number of points contributed by each user preference. This number of points associated with each user preference will be the ratio of the slider value for user preferences to the sum of all slider values expressed as a percentage.

In some cases, no user preference is known. For example the user may have no history and may have not set any user preferences. In that case, each wine will receive zero points for user preferences.

The manner in which recommendation points are awarded as a result of wine critics' recommendations is similar to that described for friends' recommendations. However, in some embodiments, the wine critic recommendation is not binary as was the case in the “friends” recommendation points described above. Nevertheless, the over-arching principle is the same. There exists a maximum number of points that can possibly be awarded by all the wine critics. This maximum value is controlled by the slider value for wine critics. In the example above, the slider was {0.27, 0.7, 0.4, 0.8}, with the 0.8 corresponding to the wine critics. Thus, maximum number of points that can possibly be awarded by all the wine critics would be 36.86, which is the ratio, expressed as a percentage, of 0.8 to the sum of the slider values, 2.17.

As an example of how wine critics are used to assign recommendation points, suppose for a particular wine there are four wine critics. One of them did not rate that particular wine, whereas the other three assigned that wine values of 97%, 91%, and 72%. In that case, the average rating would be 86.67%. Thus, that wine would receive a total of (0.8667)(36.86) or 31.94.

The number of recommendation points for a particular wine is thus obtained by adding up the number of points calculated as described above across each slider value. This number is then incremented or decremented depending on history. Thus, even if a wine has a great many recommendation points as a result of the slider values, that wine will eventually have its score reduced if it is consistently ignored by the user.

As noted above, the list of suggested wines has a minimum number, which in one embodiment is nine. This means there must be a procedure for selecting a subset of wines from a list provided by the restaurant to ensure that this constraint is satisfied. In one practice, the procedure is to first exclude all wines that do not satisfy all search parameters. If the resulting subset has more than the minimum number, the recommendation procedure begins. Otherwise, one of the constraints is relaxed and the procedure repeated until the proper number of wines is in the subset. To the extent that a person is more likely to spend a little more than to switch to a less attractive wine, the most convenient constraint to relax is often the price range.

In one embodiment, the recommendation system is configured to interact with a social network to enable informed gift giving of a wine. A user of the wine recommendation system may have a personal web page on a social network site, such as an AFFLUENCE or FACEBOOK page. Such a personal web page can provide a link to a user's account on the wine recommendation system, thus enabling others to see that person's wine preferences and wine wish list. As a result, a wine donor wishes to give a gift of wine to that user can inspect such information through the personal web page and thereby select, as a gift, a wine that the user is likely to enjoy.

In some cases, it may be economically advantageous to place one or more components of the system described herein in a different political subdivision. However, in many such cases, the system will be controlled by and operated for the benefit of residents of a first jurisdiction even though part of the system is in a second jurisdiction.

### Use Cases

### Example One

In one example use case, Tzafi's friend Geir sends her a link to the wine recommendation system application. She installs it on her mobile smart phone. In preparation for going to Napa Valley for the weekend with her friends, Tzafi wants to be ready to try new wine experiences, but does not feel very experienced with American wine choices.

The wine recommendation system application presents a splash screen and after 2 seconds changes to a welcome message inviting Tzafi to set up her wine recommendation system profile. Tzafi learns that there are 3 choices of wine recommendation system user profiles; she feels comfortable with choosing the ‘anonymous’ wine recommendation system profile based upon the descriptions. It will allow her to have most of the benefits of the full profile, but she doesn't have to be concerned about embarrassing herself. Later, once she feels more experienced in selecting wines and safely sharing her choices with selected individuals, she can upgrade to a full profile. The application issues a “Captcha” challenge, which Tzafi meets by entering text into the text box provided. The application then provides Tzafi with an automatically generated, nondescript user name and a link to a website where she can choose a password and select a password hint.

The user name is kept on Tzafi's mobile phone in an unencrypted format so that she doesn't have to remember it. It can be recovered easily. The wine recommendation system application asks Tzafi if she wants to email her user name and password to her account for safekeeping. The user name can be emailed to her email address for safe keeping.

After selecting the settings for the five selections, she is invited to activate her favorite social networks. Tzafi selects AFFLUENCE and FOURSQUARE, both of which she uses regularly.

Because Tzafi and some of her friends are headed to Napa Valley on the weekend, she decides to post a note on her AFFLUENCE account. She then selects the journaling tab to see what it offers and how she can use it to document her trip.

Tzafi has never been to the Napa Valley, so she is curious about the types of restaurants near the wineries and the hotel. American food is very different from that of her family's middle-eastern style of cooking, but she is looking forward to trying some. Tzafi was told by a business colleague to try a particular restaurant that has an excellent reputation for dinner menus and an extensive wine selection.

The wine selection consists predominantly of regional wines to cater to both the experienced locals and the diverse tourists. She looks to see if the restaurant's wine list has any interesting comments and recommendations. There are some comments by wine critics, all of whom are unknown to her. She is intrigued by two choices and so she touches the name of the first wine to learn more about it. It sounds interesting and although slightly out of her price range, she thinks that the group setting will mean they could afford it. So she puts the wine into her wine barrel. She then asks the wine recommendation system to suggest similar style wines but at a lower price range just in case. She likes two of the choices and also places them into her wine barrel. She opens the wine barrel and notices that each wine is represented by an image of its label and a short description. It also has the familiar smart phone ability to pull up a separate page with more complete information. Tzafi notices that at the bottom of the wine barrel there is an option to post selections to her social network. She decides to post to AFFLUENCE with the comment that she hopes to try one of these wines over the weekend; someone else will probably post a comment, which will be sent to her wine recommendation system application.

Tzafi also notices that there are comments about the food and about pairings between wines and foods. She notes the scallops on the menu and enters that selection. The list of recommended wines now changes in response to her selection.

### Example Two

John and his business colleagues are meeting at Ristorante Giordana for a relaxing meal following a day of client meetings near Waterloo, Ontario. Originally from Calgary, John moved to Toronto earlier in the year to manage this group. John has heard a lot about the wines from the Niagara region, most of which were not available in Alberta.

Although there will not be any clients at the meal, John realizes that the competitive nature of his sales and marketing team means that wine selection will keep him on his toes. Like any business event, the expense account is a great advantage in trying wines from price ranges that might ordinarily cause his wife to cringe. However even expense accounts have limits, so he will need to keep the pricing below $100 per bottle.

John downloaded the wine recommendation system mobile application 12 onto his smart phone while in the airport the previous evening. He registered with the full profile using a wine recommendation system user account. After dismissing the FACEBOOK social network setup, he noticed that LINKEDIN and AFFLUENCE were supported, so he activated these sites.

John provided the following information in his profile: his restaurant purchases typically range from $80-$120; he enjoys valpolicella, ripasso, Washington merlot, and Spanish Rioja at business dinners; he prefers red wine; he enjoys pairing his wine selection with his food; and he wants to explore other Italian red wines for this event.

The group is seated and the waiter describes the evening specials. Rainbow trout and local lamb seem to be popular choices. John's colleagues had passed him the wine list early in the evening with one of them telling the waiter that the Albertan would appreciate their large selection. He decided to try the wine recommendation system mobile application 12 before talking with the sommelier so that he would at least look like he knew what he was talking about.

The wine list was ten pages long and John was intimidated at the thought of photographing the entire list. He selected the camera tab in the application 12. The application 12 asked to use his location and then indicated that he had good connectivity. The application 12 even said that there was Wi-Fi available. He took a picture of the first page and appreciated the guides provided by the application 12. It looked focused, so he clicked. The camera flashed, and shortly thereafter, a swooshing sound indicated that the image had been transmitted to the recommendation engine 20. Before he could photograph the second page, an alert appeared asking if he was at the Ristorante Giordana in Smallville. The system had recognized the first page of the wine list and observed that the complete wine list was already available. As a result, there was no need to photograph all ten pages. He gratefully selected “yes.” VCapp indicated that it had two questions in addition to John's existing profile. Answering these two questions resulted in a new screen with some recommended wines listed.

### Example Three

Although still apprehensive about selecting wines, a wine lover is accustomed to using the mobile application 12 to select wines. He has even started bragging about his choices and experiences to their FACEBOOK account. The initial purchases have gone smoothly. So, an element of trust has developed.

He has installed the updated version. The mobile application 12 asks for some information as part of its wine drinking profile. It also asks for approval to continue using the previous social networking and location-based service settings. The user is anticipating selecting wines based upon the additional information and to using the journaling functionality.

He can evaluate the wine more precisely than by merely indicating a like or a dislike. He can also add personalized written comments. These comments are tagged to his profile and published to the social networks of his choice.

The mobile application 12 checks back with the user about his wine selection and offers to order the same wine for delivery to his home. The application 12 informs the user that he can now share photographs and videos of the experience with his FACEBOOK friends. This is a familiar ability and he tries it out by taking a picture of the wine bottle and the restaurant, then posting it to his FACEBOOK account.

### Example Four

Devon finished her call and an alert box from the wine recommendation system mobile application 12 appeared on her smart phone. Curious, she scrolled across her many apps and noticed that the badge displayed a red “2.”

Devon accessed the wine recommendation system application. The application took her to a page saying that two of her recent favorite wines were now on sale: one through an internet provider and the other at a local wine shop near her office. She noted that the latter even provided the ability to purchase on-line with optional shipping for a nominal extra charge, which was currently waived for members of the wine recommendation system

A click on the first wine choice brought up a short visual reminder of the wine, complete with some of her comments and a carousel of photographs. Although it had been about two weeks since she had tasted these wines, the experience came flooding back. “Ah yes,” she thought, “that was a great wine, I think that I will order several bottles.” So she proceeded to the wine recommendation system eCommerce page to complete the purchase.

It is to be understood that the foregoing description is intended to illustrate and not to limit the scope of the invention, which is defined by the scope of the appended claims. Other embodiments are within the scope of the following claims.

1. A computer program product, tangibly embodied on a computer readable medium, comprising instructions that, when executed by a data processor of a portable electronic device, cause the data processor to obtain a list of wines available at a commercial establishment, identify at least one attribute associated with each wine included on the list of wines, for each wine included on the list of wines, determine a score based at least in part on the at least one attribute and at least one of a characteristic associated with the user and a preference input by the user, said score being indicative of a likelihood that the user will purchase the wine, at least in part based on the score, identify at least one recommended wine for recommendation to the user, and present the at least one recommended wine on a display interface of the portable electronic device.

2. The computer program product of claim 1, wherein obtaining the list of wines includes obtaining an image of a menu, and processing the image to obtain the list of wines.

3. The computer program product of claim 1, wherein obtaining the list of wines includes identifying the commercial establishment, and retrieving an electronic representation of the list of wines from a wine list database.

4. The computer program product of claim 3, wherein identifying the commercial establishment includes receiving an input from the user identifying the commercial establishment.

5. The computer program product of claim 3, wherein identifying the commercial establishment includes identifying the commercial establishment based on a GPS signal indicative of a location of the portable electronic device.

6. The computer program product of claim 3, wherein obtaining the list of wines further includes receiving an image of a menu, processing the image to obtain an image-derived list of wines, and comparing the image-derived list of wines with the electronic representation of the list of wines.

7. The computer program product of claim 1, wherein the attribute includes a professional rating of the wine.

8. The computer program product of claim 1, wherein the attribute includes a a peer group rating of the wine.

9. The computer program product of claim 1, wherein identifying at least one attribute includes, for each wine determining an identifier of the wine based on information included in the list of wines, and retrieving, from a wine attribute database, the at least one attribute associated with the identifier of the wine.

10. The computer program product of claim 9, wherein the information included in the list of wines includes at least one of a variety, a year, a winery, a location, and a price.

11. The computer program product of claim 1, wherein the preference input by the user includes a preference based on a price of the wine.

12. The computer program product of claim 1, wherein the preference input by the user includes a preference based on a price of the wine.

13. The computer program product of claim 1, wherein the preference input by the user includes a preference based on physical properties of the wine.

14. The computer program product of claim 1, wherein the preference input by the user includes a preferred food-wine pairing.

15. The computer program product of claim 1, wherein the characteristic associated with the user includes a history of wine purchases.

16. The computer program product of claim 1, wherein the characteristic associated with the user includes a history of wine ratings.

17. The computer program product of claim 1, wherein the characteristic associated with the user includes a history of wine pairings.

18. The computer program product of claim 1, wherein the at least one characteristic associated with the user includes a rating of at least one of the wines included on the list of wines by another user connected via a social network to the user.

19. The computer program product of claim 1, wherein the instructions further cause the data processor to prompt the user to provide feedback associated with the recommended wine.

20. The computer program product of claim 19, wherein feedback associated with the recommended wine includes information indicating that the user purchased the wine.

21. The computer program product of claim 19, wherein feedback associated with the recommended wine includes information representing a rating of the recommended wine.

22. A system for recommending a wine to a user, comprising a wine list module configured to obtain a list of wines available at a commercial establishment, a wine identification module configured to identify at least one attribute associated with each wine included on the list of wines, a scoring module configured to, for each wine included on the list of wines, determine a score based at least in part on the at least one attribute and at least one of a characteristic associated with the user and a preference input by the user, said score being indicative of a likelihood that the user will purchase the wine, a recommendation generation module configured to identify, based on the score, at least one recommended wine for recommendation to the user, a presentation module configured to present the at least one recommended wine on a user interface of a portable electronic device.
